(19) United States
(12) Patent Application Publication
(10) Pub. No.: US 2002/0140201 A1
(43) Pub. Date: Oct. 3, 2002

(54) Fork-axle interface for improved tracking

(76) Inventor: Friedrich James Kirk, Chico, CA (US)

Correspondence Address: Friedrich J. Kirk, 633 Orange Street #6, Chico, CA, 95928, US

(21) Appl. No.: 09/823,684

(22) Filed: Mar. 31, 2001

Related U.S. Application Data
(60) Provisional application No. 60/256,869, filed on Dec. 19, 2000.

(51) Int. Cl. B62K 1/00

(52) U.S. Cl. 280/279; 280/288

(57) ABSTRACT

Lack of torsional rigidity is a problem all suspension forks have to one degree or another. This leads to problems with control and tracking. This invention solves the problem by using a new process with modifications to the design of existing components. Torsional load problems are solved at their origin by transmitting torsional loads between the fork legs. This reduces independent leg motion, resulting in precise steering performance.

I hereby claim the benefit of the earlier filing date of my pending U.S. Provisional Application for Patent Serial No. 60/256869 filed Dec. 19, 2000.

I hereby note the existence of the document disclosure program document serial no. 370974 filed Jul. 2, 1995 also pertaining to this invention.

### BACKGROUND

1. Field of Invention

The invention relates to the interface between the axle and the lower end of the fork of either the front or rear of a two wheeled or three wheeled vehicle, such as a bicycle or motorcycle.

2. Description of Prior Art

The forks that connect the front and rear wheels on motorcycles and bicycles are subjected to distinct loading situations. The front fork is subjected to the following four load cases: The first is a frontal impact, which is transmitted through the wheel to the axle, forcing the fork back and up into the frame. The second is a compression load, forcing the wheels upward toward the crown of the fork. The third is a side load, forcing the wheel to move sideways within the fork. The fourth is a twisting load, causing the wheel to twist relative to the crown or handlebar position.

Current designs for suspension forks on motorcycles and bicycles handle the first three load cases well. The first load case is resolved by making fork legs strong enough to not deflect. The second load case is usually absorbed by the spring-damper internals of a suspension fork or transmitted easily by compression loading in the fork legs. Generally a structure strong enough to take the loads of the first load case can easily resist the forces of the second load case. The third load case is resolved by either making a fork brace or a strong axle to transmit the bending loads evenly to both fork legs.

The fourth load case is not as easy to resolve, compounded by the fact that on telescoping suspension forks, the lower legs can twist relative to the upper legs. Therefore, the individual legs cannot offer any torsional input to the torsional performance of the fork. The obvious solutions of making stiffer fork legs, adding braces, or making stiffer axles have all shown only marginal improvements in performance because they have not addressed the true nature of the problem. The importance of the fourth load case becomes most apparent when operating in demanding conditions or at high speed. In these situations, it is very important that the vehicle respond instantly and accurately to rider input. If there is too much flexibility in the fork connecting to the wheel, the fork will deflect rather than turn the wheel.

Current art is a smooth cylindrical axle, usually 20 mm, that is clamped on either end by the fork legs. This system is a large improvement over the older system of pinching the fork blades between two nuts on a threaded axle. However, this system is not adequate because the clamps still rely on friction to transmit torsional loads to and from the axle. These torsional loads can easily exceed the torque transmitting capabilities of a purely frictional interface. There are two major results of this situation: 1) There is no reason to build a stronger stiffer axle because the loads can not be transmitted anyway. 2) When an axle slips in the clamp, the fork is forced into a twisted configuration that causes binding and severe geometry changes to the vehicle. It is not uncommon to see a downhill mountain bike racer attempting to straighten a twisted fork by holding the wheel in their knees and twisting the handlebars in the opposite direction.

### OBJECTS AND ADVANTAGES

It is the object of the present invention to fully describe and quantify the problem of torsional deflection in the forks that connect the wheel to the vehicle.

It is the object of the present invention to provide a solution to the problem of torsional flex in the forks that connect the wheel to the vehicle by providing a method of connecting the lower legs of the fork together such that their relative movement is minimized.

### DESCRIPTION OF THE DRAWINGS

FIG. 1 is a motorcycle showing the forks.

FIG. 2 is a bicycle showing the forks.

FIG. 3 is a wheel with an axle.

FIG. 4 is a suspension fork.

FIG. 5 is a suspension fork showing exaggerated deflection due to torsion loading.

FIG. 6 is a side view of a suspension fork.

FIG. 7 is a side view of a deflected suspension fork.

FIG. 8 is a top view of a deflected suspension fork.

FIG. 9 is a view of an improved dropout using a tapered square axle.

FIG. 10 is a view of a dropout using a tapered square axle rotated 45 degrees.

FIG. 11 is a view of an axle with a tapered square interface.

FIG. 12 is a view of a dropout with a rectangular interface and provisions for a quick-release.

FIG. 13 is a view of a dropout with a rectangular interface and provisions for a drop-away pressure plate.

FIG. 14 is a view of an axle with a rectangular interface and bulged center section.

FIG. 15 is a view of a dropout using a double bolt connection.

FIG. 16 is a view of an axle with a double bolt interface.

FIG. 16 is a view of a dropout using a splined through-axle.

FIG. 17 is a view of a splined through-axle.

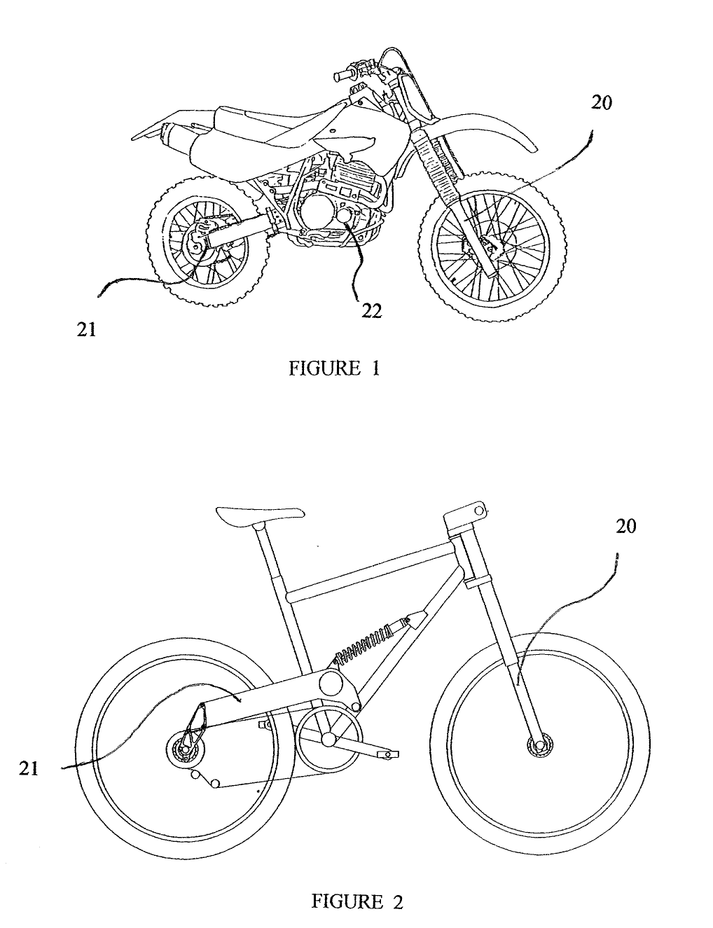

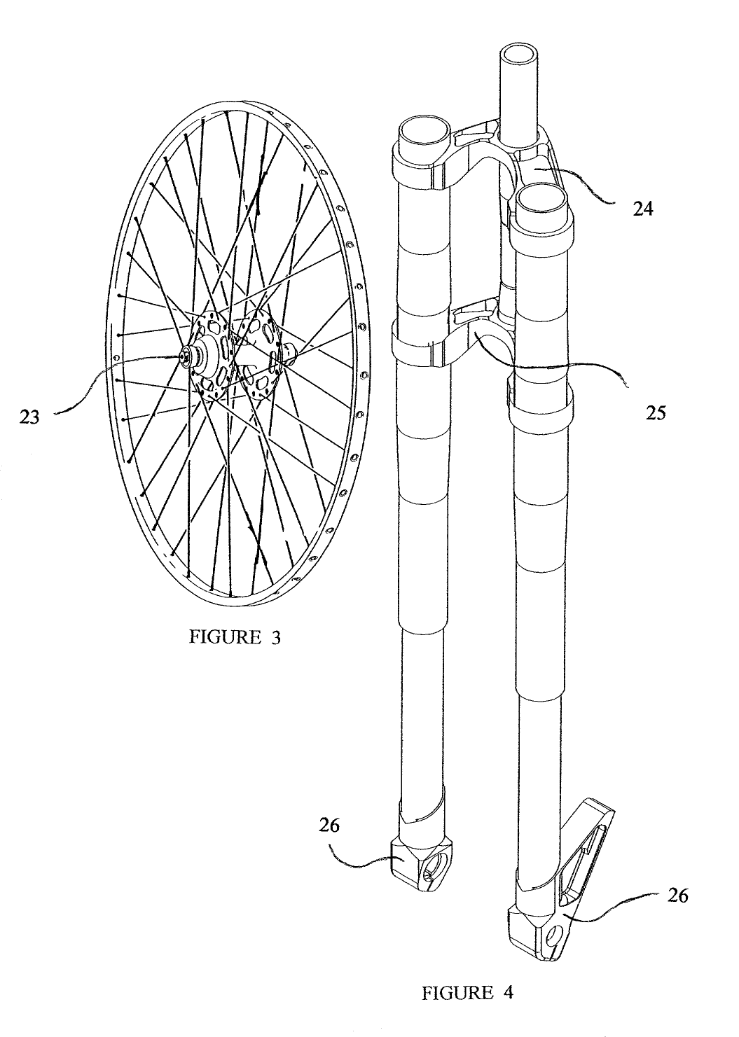

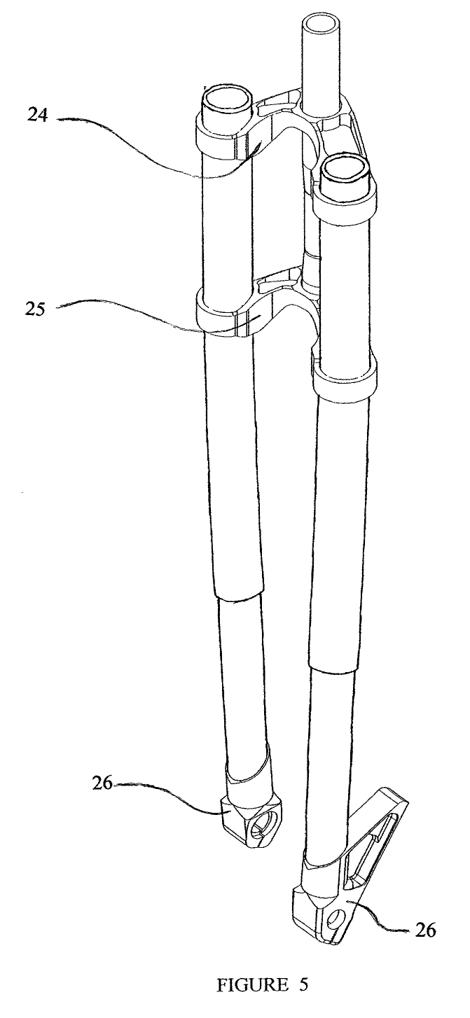

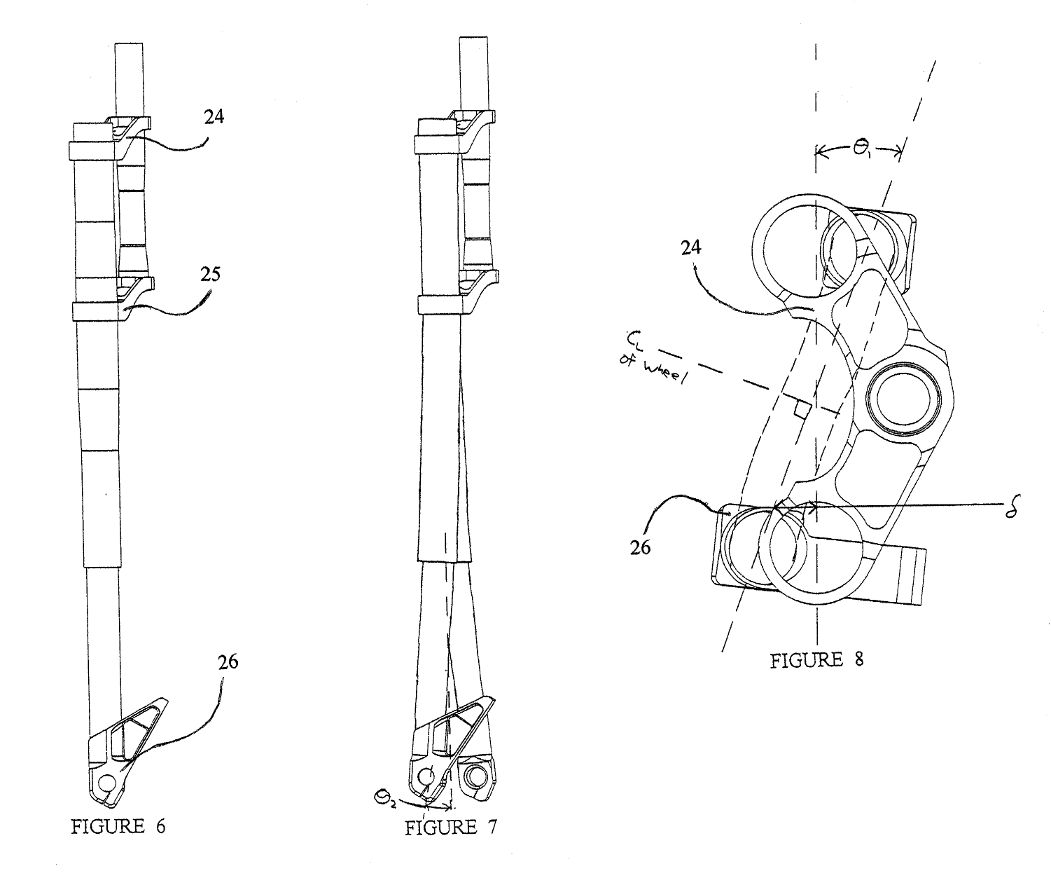

### REFERENCE NUMERALS IN DRAWINGS

20 front suspension fork 28 endpiece with tapered flats

21 rear suspension fork 29 endpiece with parallel flats

22 motor 30 endpiece with tension screws

23 axle 31 endpiece with spline

24 upper crown 32 dropout with splined socket

25 lower crown 33 clamp

26 dropout 34 clamp screws

27 axle center section

### DESCRIPTION OF THE INVENTION

A torsionally stiff axle would be required of the system. An axle can be considered “torsionally stiff” if it falls in the criteria described in paragraph four of “theory of operation.” Essentially, if an axle is torsionally rigid enough to bend the lower leg of the fork, it is considered “torsionally rigid” for purposes of this discussion.

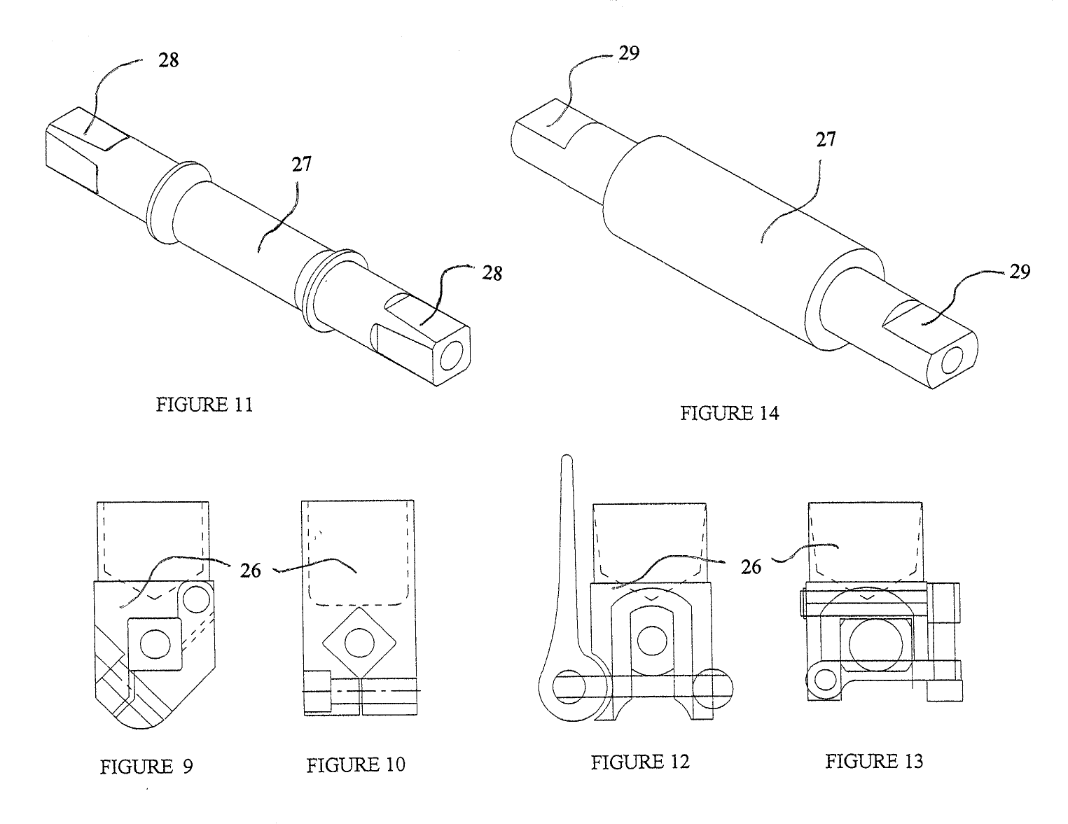

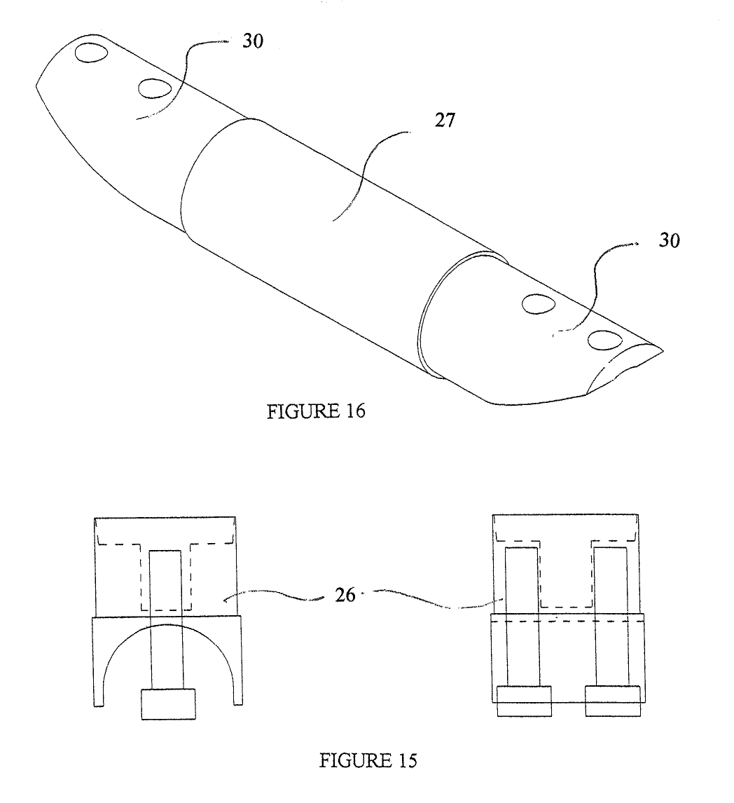

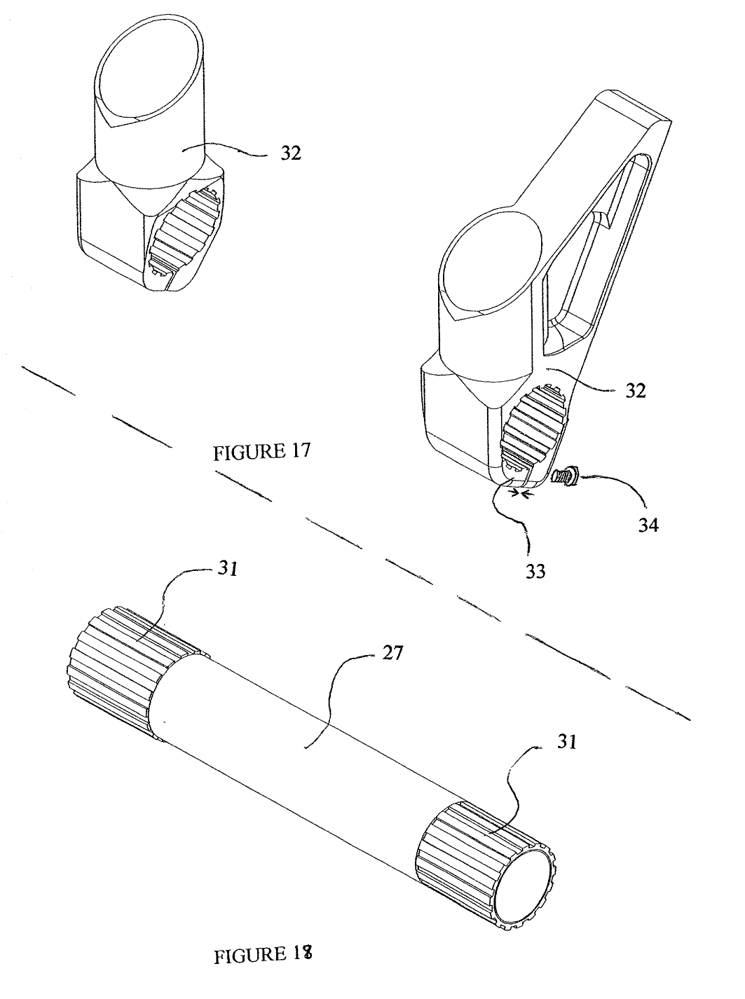

A torsionally rigid axle, with end details such as but not limited to those shown in FIGS. 9 through 17, is part of a wheel. The axle inserts into a dropout, as shown in FIG. 9, having a socket that corresponds to the ends of the axle. The axle/dropout interface is built such that the two parts cannot axially rotate relative to each other. For this invention to be effective, even a small amount of rotational movement (as little as ½ degree), or rocking of the axle in the socket, can not be tolerated as this allows a large amount of fork torsion.

This interface that allows no rotation can be accomplished by a variety of methods. One of these would be to weld or bond the parts together; however, this is impractical because the parts will need to be separated to perform routine maintenance. Most practically, the two parts should have a method of transmitting torque to each other that does not rely on a frictional interface. A frictional interface is considered a “nonpositive” securing method because it will allow both rocking and spinning of the axle if the torque transmitted through the axle exceeds the frictional clamping capability of the dropout.

This system requires a “positive” securing method. For purposes of the discussion, any combination of axle end detail and fork dropout socket that would require displacement of material for rotation or rocking to occur would be considered “keyed” or “positive”. Any such axle that has a non-constant radius would be considered keyed, if matched to a socket of the same design. Thus an axle with a elliptical shape could be considered keyed as an axle with a slot for a keyway is considered keyed.

A keying structure, such as those defined above, will allow no rotational movement or rocking, yet allow for dissassembly. For best results, there should be a means to preload the interface between the two parts to reduce the possibility of the two parts moving slightly or rocking due to tolerance variations. This can be done by a means of press fitting the parts together by providing tapered keys or providing a pinch clamp arrangement.

Theory of Operation

When a fork is not subject to any loads, the wheel forms a plane perpendicular to the handlebars which will be called the “neutral plane.” When the wheel is forced out of the neutral plane, it forms an angle q1 with the neutral plane. This also twists the axle out its plane by the same angle. The end of the axle is moved a distance d away from its neutral position, described by equation 1. Because the ends, or dropouts, are connected to the ends of the axle, one leg of the fork is forced to move forward and rotate the angle q1 around the centerline of the fork leg. The other leg is moved backward and rotates the angle q1 in the opposite direction. Because the lower legs of telescoping suspension forks are designed to move freely, there will also be no resistance to rotating.

When a fork leg with the current art axle/fork interface is bent a distance d, it bends the leg into an arc. This is described by equations 2 through 3, 5, and 6. The angle of the fork end with respect to the axis of the fork leg is q2. Because one end moves backward while the opposite moves forward, one end is rotating −q2 and the opposite side is rotating +q2. Relative to each other, the fork ends are moving twice that, or 2×q2.

If the dropouts of the fork are keyed to the axle, the rotation of the fork ends will load the axle torsionally. If the axle is torsionally rigid, it can transmit a significant amount of torque from one dropout to another, forcing the dropouts to stay rotationally fixed. The torsional rigidity of an axle is described by equation 7 and 8. If this is accomplished, the fork is bent into an “S” shaped bend, rather than a simple arc, as described by equation 4.

The main restrictions on this theory are that a torsionally rigid axle is used and that the axle/dropout interface have no chance of twisting or rocking.

Current design forks use a smooth cylindrical shaft, called a through axle, design whereby the axle is clamped by the dropouts. The problem with this design is that a clamp to a smooth shaft cannot transmit the necessary amount of torque without slipping. This is described by equations 9 through 11. Clamps are limited by the amount of material that can be used to wrap around the axle. Because of weight constraints, these clamps are usually aluminum and are often thin wall, less than 0.200″. Because of hoop stress limitations of the tensile strength of aluminum, this type of clamp can only exert 400 lbs of normal force on the axle. Under ideal conditions, this type of clamp could only transmit 218 foot-pounds of torque due to the frictional force exerted by aluminum on aluminum. This can easily be exceeded by twisting a fork as little as three degrees.

Theory of Operation—Equations and Nomenclature

Variables used in the following equations:

q1: Angle between neutral plane and plane wheel is twisted into

Lfork: length of fork, measured from bottom crown to axle

Dleg: Outer diameter of fork leg

dleg: Inner diameter of fork leg

Ifork: moment of inertia of fork legs

Efork: modulus of elasticity of fork leg

Ffork: force required to deflect fork leg d

Tfork: torque exerted on fork end by axle

d: Distance fork ends are deflected due to torsional deflection

q2: angle of bottom of fork leg when twisted relative to relaxed state in order to deflect d

Laxle: length of axle, measured from insides of fork contacts

Daxle: outer diameter of axle

daxle: inner diameter of axle

Jaxle: polar moment of inertia of axle

Gaxle: modulus of rigidity of axle

Taxle: torque exerted through axle

sclamp: allowable stress in clamp

tclamp: thickness of clamp

Lclamp: length of clamp

Fclamp: force exerted into clamp material for clamping pressure

pclamp: pressure exerted on axle by clamp

uclamp: coefficient of friction between clamp and axle

Fork Torsion Equations, Source: Machinery's Handbook

| | | |
|---|---|---|
| 1) | $tan ( q1 ) = \frac{d}{Laxle / 2}$ | Calculate the deflection of the fork leg |
| 2) | $Ifork = \frac{p * ( Dleg \hat{} 4 - dleg \hat{} 4 )}{64}$ | Calculate the moment of inertia of a fork leg |
| 3) | $d = \frac{- Ffork * Lfork \hat{} 3}{3 * Efork * Ifork}$ | Calculate the force exerted to bend the fork leg assuming a simple arc |
| 4) | $d = \frac{- Ffork * Lfork \hat{} 3}{12 * Efork * Ifork}$ | Calculate the force exerted to bend the fork assuming a “guided” bottom leg |
| 5) | $tan ( q2 ) = \frac{- Ffork * Lfork \hat{} 2}{2 * Efork * Ifork}$ | Calculate the angle of the fork leg at the bottom |
| 6) | $tan ( q2 ) = \frac{Tfork * Lfork}{Efork * Ifork}$ | Calculate the torque required to bend the fork leg |

axle deflection calculations

| | | |
|---|---|---|
| 7) | $q2 = \frac{Taxle * Laxle / 2}{Gaxle * Jaxle}$ | Calculate the angular deflection of the axle (Must convert to degrees) |
| 8) | $Jaxle = \frac{p * ( Daxle \hat{} 4 - daxle \hat{} 4 )}{32}$ | Calculate the axle's polar moment of inertia |

clamp strength calculations, assuming the material of the clamp
is the weakest link

| | | |
|---|---|---|
| 9) | Fclamp = sclamp * | Calculate the force |
| | LClamp * tclamp | the clamp can exert |
| 10) | 2* Fclamp = pclamp * | Calculate the |
| | Daxle * Lclamp | pressure exerted |
| | | on the axle |
| 11) | $\frac{Taxle}{Daxle / 2} = uclamp * pclamp$ | Calculate the torque that can be Transmitted through the clamp |

Operation of the Invention.

An axle with keyed end details matching its corresponding dropout is inserted into the dropouts on the end of the fork. The dropout is then clamped tightly by means of a bolt or quick release lever to eliminate the possibility of the axle rocking slightly in the dropout. The rider will experience greatly improved tracking characteristics at high speed or adverse conditions.

### Summary, Ramifications, and Scope

Suspension fork designs have evolved to an optimised state of weight versus torsional rigidity. All other loading situations have been successfully addressed. However, its been found that only marginal gains in torsional rigidity can be realized by adding more material and thus, weight.

This invention significantly changes the problem. By using this system, loads are resolved at their origin, rather than the crown-leg interface. Rather than increasing he stiffness of an already stiff member, it is now practical to increase the strength of a relatively weak connection and make significant improvements to the system.

Although the description above contains many specificities, these should not be construed as limiting the scope of the invention but as merely providing illustrations of some presently preferred embodiments of this invention. For example, the keyed structure can have many shapes, such as equilateral polygons.

Thus the scope of the invention should be determined by the appended claims and their legal equivalents, rather than by the examples given.

I claim:

1. An improved land vehicle of a type having at least a first fork member and a second fork member, the fork members positioned one on each opposite side of a ground contacting wheel with the wheel positioned between the fork members and the wheel rotatably supported on a wheel support axle, the axle having a first end and a second end, the first fork member having a socket holding the first end of the axle; the second fork member having a socket holding the second end of the axle;
wherein the improvements comprise:
the first end of the axle includes a keying structure interfacing with a correlating keying structure of the first axle socket of the first fork member, the correlating keying structures of the first end of the axle and first socket sufficiently close to one another as to prohibit spinning or rocking of the first end of the axle within the first socket;
the second end of the axle includes a keying structure interfacing with a correlating keying structure of the second axle socket of the second fork member, the correlating keying structures of the second end of the axle and second socket sufficiently close to one another as to prohibit spinning or rocking of the second end of the axle within the second socket.

2. An improved land vehicle according to claim 1 further including improvements comprising:
a user adjustable first clamp at least in part defining the first axle socket; wherein the first clamp can be adjusted to force the correlating keying structures of the first end of the axle and the first socket into tight engagement;
a user adjustable second clamp at least in part defining the second axle socket; wherein the second clamp can be adjusted to force the correlating keying structures of the second end of the axle and the second socket into tight engagement.

3. An improved land vehicle according to claim 2 further including improvements comprising: the axle ends are each positively secured relative to the associated axle holding sockets with the clamps adjusted to force the correlating keying structures of the axle ends and sockets into tight engagement, and the axle is sufficiently stiff as to be able to transfer at least a portion of any rotational torque received from rotation of the first axle socket through the axle into the second end of the axle and into the second axle socket, whereby tracking of the first and second fork members relative to one another is improved during operation of the land vehicle.

4. An improved land vehicle according to claim 3 further including improvements comprising: the correlating keying structures of the axle ends and sockets including at least a pair of flat or curved surfaces that deviate from the constant radius of the axle's surfaces, one flat or curved surface per axle end and one flat or curved surface per socket engaged with the correlating flat or curved surface of the associated axle end.

5. An improved land vehicle according to claim 4 further including improvements comprising: each of the axle ends having multiple flat or curved surfaces engaging multiple flat or curved surfaces of the associated socket.

6. An improved land vehicle according to claim 1 wherein said land vehicle is a motorcycle.

7. An improved land vehicle according to claim 1 wherein said land vehicle is a bicycle.

8. An improved land vehicle according to claim 3 wherein said land vehicle is a motorcycle.

9. An improved land vehicle according to claim 3 wherein said land vehicle is a bicycle.

10. An improved land vehicle according to claim 8 wherein the fork members of the motorcycle are front fork members at a front end of the motorcycle.

11. An improved land vehicle according to claim 9 wherein the fork members of the bicycle are front fork members at the front end of the bicycle.

12. An improved land vehicle of a type having at least a first fork member and a second fork member, the fork members positioned one on each opposite side of a ground contacting wheel with the wheel positioned between the fork members and the wheel rotatably supported on a wheel support axle, the axle having a first end and a second end, the first fork member having a socket holding the first end of the axle; the second fork member having a socket holding the second end of the axle; wherein the improvements comprise:
the first end of the axle includes at least one flat or curved structure that deviates from the otherwise constant radius of the axle interfacing with a correlating flat or curved structure of the first axle socket of the first fork member, the correlating flat or curved structures of the first end of the axle and first socket sufficiently close to one another as to prohibit spinning of the first end of the axle within the first socket;
the second end of the axle includes at least one flat or curved structure that deviates from the constant radius of the axle interfacing with a correlating flat or curved structure of the second axle socket of the second fork member, the correlating flat or curved structures of the second end of the axle and second socket sufficiently close to one another as to prohibit spinning of the second end of the axle within the second socket;
the first axle socket at least in part defined by a user adjustable first clamp; wherein the first clamp can be adjusted to force the correlating flat or curved structures of the first end of the axle and the first socket into tight engagement;
the second axle socket at least in part defined by a user adjustable second clamp; wherein the second clamp can be adjusted to force the correlating flat or curved structures of the second end of the axle and the second socket into tight engagement; the axle is sufficiently stiff as to be able to transfer at least a portion of any rotational torque received from rotation of the first axle socket through the axle to the second end of the axle and into the second axle socket, whereby tracking of the first and second fork members relative to one another is improved during operation of the land vehicle.

13. An improved land vehicle according to claim 12 the land vehicle is a motorcycle.

14. An improved land vehicle according to claim 12 the land vehicle is a bicycle.

15. An improved land vehicle of a type having at least a first fork member and a second fork member, the fork members each on opposite sides of a wheel with the wheel positioned between the fork members and the wheel supported on a wheel support axle, the axle having a first end and a second end, the first fork member having a socket engaging the first end of the axle; the second fork member having a socket engaging the second end of the axle;
wherein the improvements comprise:
means engaging the first end of the axle and the first axle socket of the first fork member for positively securing the first end of the axle to the first axle socket; and
means engaging the second end of the axle and the second axle socket of the second fork member for positively securing the second end of the axle to the second axle socket; and said axle sufficiently rigid to be able to receive rotational force from the first axle support and to transfer at least a significant amount of the rotational force through the rigid axle into the second axle support, whereby tracking of the first and second fork members relative to one another is improved during operation of the land vehicle.

16. An improved land vehicle according to claim 15 wherein said means engaging between the first end of the axle and the first axle socket includes a flat or curved surface deviating from the constant radius on the first end of the axle against a flat or curved surface in the first axle socket; and
said means engaging between the second end of the axle and the second axle socket includes a flat or curved surface deviating from the constant radius on the second end of the axle against a flat or curved surface in the second axle socket.

17. An improved land vehicle according to claim 16 wherein said land vehicle is a motorcycle.

18. An improved land vehicle according to claim 16 wherein said land vehicle is a bicycle.

19. A method of improving cooperative tracking between a first fork member and a second fork member on a land vehicle; comprising the steps of
a) providing an axle which is torsionally rigid;
b) positioning said axle through a wheel hub to be supported between the fork members;
c) positively securing a first end of said axle to said first fork member;
d) positively securing a second end of said axle to said second fork member with the wheel hub positioned between the fork members.

20. A method of improving cooperative tracking according to claim 19 wherein said positive securing of said first end of said axle to said first fork member includes keying said first end of said axle to said first fork member.

21. A method of improving tracking between a first fork member and a second fork member on a land vehicle; comprising the steps of
a) providing an axle;
b) positioning said axle through a wheel hub to be supported between the fork members;
c) positively securing a first end of said axle to said first fork member;
d) positively securing a second end of said axle to said second fork member with the wheel hub positioned between the fork members.

22. A method of improving cooperative tracking according to claim 21 further including providing said axle in a form which is torsionally rigid.

23. A method of manufacturing a fork to axle interface comprising the steps of
a) providing an axle which is torsionally rigid;
b) positioning said axle through a wheel hub to be supported between the forks;
c) positively securing a first end of said axle to a first fork member of the forks;
d) positively securing a second end of said axle to a second fork member with the wheel hub positioned between the forks.

24. A method of manufacturing a fork to axle interface according to claim 23 wherein the positive securing of said first end of said axle to said first fork member includes keying.

25. A method of manufacturing a fork to axle interface according to claim 24 further including mounting the first and the second fork members to a motorcycle.
